(19) United States
(12) Patent Application Publication
(10) Pub. No.: US 2005/0151007 A1
(43) Pub. Date: Jul. 14, 2005

(54) Deployable, rigidizable wing

(76) Inventors: David P. Cadogan, Middletown, DE (US); David Allen Graziosi, Magnolia, DE (US); Grant Ryan Lee, Kemah, TX (US); Stephen Emerson Scarborough, Seaford, DE (US); Timothy R. Smith, Magnolia, DE (US)

Correspondence Address: STEVENS, DAVIS, MILLER & MOSHER, L.L.P., Suite 850, 1615 L Street, N.W., Washington, DC, 20036, US

(21) Appl. No.: 10/770,130

(22) Filed: Feb. 3, 2004

Related U.S. Application Data
(60) Provisional application No. 60/444,665, filed on Feb. 4, 2003.

(51) Int. Cl. B64C 3/00

(52) U.S. Cl. 244/35 R

(57) ABSTRACT

A novel design and construction method for an inflatable, rigidizable wing for a terrestrial or planetary flying vehicle. The wing is caused to deploy from an initially packed condition and to assume its functional shape by means of an inflation gas. After inflation, the wing is rigidized by any of several means, such that the inflation gas is no longer required. The composite wing is fabricated from a base reinforcement material, often a fabric, which is coated with a polymer resin that hardens when exposed to a curing mechanism. Several activation mechanisms exist by which to initiate rigidization of such a structure, including elevated temperature, ultraviolet light, and chemical constituents of the inflation gas. The resultant wing has fundamental advantages compared to existing inflatable wings, including improved stiffness, and reduced susceptibility to structural failure in response to puncture.

This application is a non-provisional application of U.S. Provisional Application No. 60/444,665, filed Feb. 4, 2003, incorporated by reference in its entirety (including all of the references discussed therein).

### BACKGROUND OF THE INVENTION

1. Field of the Invention

The present invention relates to the field of expandable structures which can be subsequently rigidized to be self supporting and finds utility in aircraft components, specifically wings, which can be inflated and rigidized to prevent deformation thereof.

2. Background

Inflatable wings have been in existence for decades and have found application in a variety of manned and unmanned aircraft, and as control surfaces for munitions and Lighter Than Air (LTA) vehicles such as aerostats. Recent technological advances, in the context of a society that is increasingly risk averse, have resulted in increased interest in the use of Unmanned Aerial Vehicles (UAVs). Many of the vehicles under development require the ability to stow their wings into very small volumes for more efficient storage and transport, and also to facilitate air, ground, or sea deployment from a gun, launch tube, or bomb rack. One technology that has shown promise in achieving this goal is the inflatable wing.

Inflatable wings can be packed into volumes that are a fraction of their deployed volume without damaging the structural integrity of the wing. Deployment can occur on the ground or in flight in a very short duration on the order of a few seconds or less. The source of inflation gas can be a burning propellant (hot gas generator), bottled compressed gas, or a combination device known in the art as a “cold gas generator”. After they are initially deployed, inflatable wings require a reserve quantity of “make up gas” to maintain inflation pressure in the face of ambient temperature changes, pressure variations with altitude, and to make up for any leakage or permeation that might occur.

Several construction methods have been employed in the art to create inflatable wings. A drop thread system is described by and Sebrell (U.S. Pat. No. 3,957,232) in which the upper and lower surfaces of the wing are held together by a multitude of threads, in a manner that causes the upper and lower surfaces to assume an airfoil shape. Another widely discussed approach is based on pressure filled cylindrical tubes. Sebrell puts forth the basic method, with variants later offered by Haggard (U.S. Pat. No. 6,082,667), and Hsia (U.S. Pat. No. 6,398,160). Common to these methods is the use of one or more pressure filled fabric cylinders to form the load bearing structure of the wing, with various methods employed to create the outer surface of the airfoil. In some cases, several tubes of varying diameter are used, with a covering stretched over the tubes to form the airfoil surface. In another case, open cell foam fills in the valleys between the tubes, and a covering is applied over top. Yet another variation uses two tubes as part of a spar structure, with ribs (referred to as hoops) defining the airfoil surface. An alternate approach, uses vertical fabric spars to connect an upper and lower restraint surface together. The resulting “spar and restraint” structure is characterized by a bumpy cross section of alternating spars and voids, into which may be fitted a gas-retaining bladder. The structure may be used as an airfoil as is, or may make use of a stretched covering over top or a combination of foam and covering to achieve the airfoil shape. Each of the documents discussed above are hereby incorporated by reference in its entirety.

Common to all of the aforementioned inflatable wing construction methods is reliance on an inflation gas to maintain the shape and structural integrity of the wing. This poses a disadvantage, because it makes the wing susceptible to loss of gas arising from construction defects, such as leaks at seams and joints, or permeation of inflation gas through the gas retaining membrane. Further, the wing can develop leaks as a result of damage incurred during storage, transport, or use. This is of particular concern in military applications where a wing could be the object of hostile gunfire.

A further disadvantage inherent in this approach is limited structural stiffness. The degree to which a cantilevered beam structure, such as an inflatable wing, deflects in response to a given load is governed by the length of the beam, the point of application of the load, and the area moment of inertia of the beam's cross section. A thicker wing has a higher moment of inertia, and is thus stronger than a thinner wing. In practice, in order to sustain realistic loads, an inflatable wing must be constructed with a thicker section, thicker materials, or be inflated to a higher operating pressure than is desired. Similarly, to limit the bending moment at the wing root, the wing must be of restricted span.

Another prior art technology is the development of deployable, rigidizable structures, often using inflatable deployment. These structures have similar properties to traditional fabric or film based inflatable structures, in that the material may be fashioned into closed surfaces that achieve a desired shape through application of an inflation gas. However, after rigidization, an inflatable, rigidizable structure is transformed into a rigid composite structure that no longer requires the presence of inflation gas. These structures are constructed from a base reinforcement material, often a fabric, that is coated with a polymer resin that chemically hardens when exposed to a curing mechanism. Several activation mechanisms exist by which to initiate rigidization of such a structure, including elevated temperature, ultraviolet or visible light, and chemical constituents of the inflation gas which interact with the structural fabric. A method for constructing three-dimensional structures from planar sheets of “B-stage cured” prepreg material is described by Cohee et al. (U.S. Pat. No. 5,651,848. and U.S. Pat. No. 5,874,151, each of which is incorporated by reference in its entirety).

### SUMMARY OF THE INVENTION

This invention is a deployable, rigidizable aerodynamic structure, commonly known as a wing, that does not rely on inflation pressure to maintain its aerodynamic shape. Prior to deployment and rigidization, the wing is generally compliant, able to be folded or rolled into a compact configuration such that it can be stowed in a container of minimal volume. At a chosen time, the wing can be deployed from its stowed configuration by means of an inflation gas or other means. Upon deployment, the wing assumes its desired, predetermined aerodynamic shape. After it is deployed, elements of the wing that were previously compliant may be caused to become rigid via, for example, a chemical reaction, such that the aerodynamic structure can be maintained completely or in part by the rigidized elements, and the initial means of deployment and shape maintenance is no longer required. While other means of deployment from a stowed position are possible, for purposes of describing the invention, an inflatable deployment is presumed.

The structural support members of the wing often include internal spars running through the wing in a span-wise fashion that may be rigidized to impart structural integrity to the wing. The spars may be arranged in a manner to form the underlying structure of an aerodynamic shape. The spars may consist of tubes, beam shaped structures, or a spar and restraint construction, or a combination of these approaches. The interior of the tubes (or the void that exists between the spars) may be fitted with a flexible bladder, which retains an inflation gas during deployment of the wing. In the case of spar and restraint construction, the spars may serve to constrain an upper and lower surface into an aerodynamic shape that possesses a bumpy cross-section. In the case of a tube-based construction, the tubes are preferably of varying diameter, and attached to one another at their periphery such that a similar bumpy approximation of an airfoil shape is achieved. In either method, a covering is preferably attached across the peaks of the bumps to create a smooth aerodynamic shape. The covering may or may not be rigidizable, may or may not bear a portion of the structural load, and may or may not be supported by material located in the valleys between the bumps.

The rigidizable elements of the wing can change from compliant to rigid as a result of a reaction that changes the underlying physical properties of the rigidizable material. Initiation of this reaction preferably occurs at a chosen time, and in a controlled manner. Typically, a curable resin is impregnated into a base fabric or oriented fiber layer. The resin is most often made rigid by one of several means, each possessing its own particular chemistry and technology.

The covering materials and structural elements of the wing can be multi-functional in nature, incorporating capabilities including conductive fibers for signal transfer; electrically activated fibers or embedded devices for shape control; antennas or other sensors incorporated into the covering via printing, stitching, direct writing, or related methods; or distributed fiber based electronic devices such as computing and memory circuits, solar cells, and batteries. The covering material may additionally include means for warping the wing for aerodynamic control purposes, such as an internal structure which may be pushed or pulled automatically. This may be incorporated at any location on the wing, including the trailing edge where the localized warping effect may appear as the motion of a typical aircraft flap or aileron.

It is an object of the present invention to apply rigidization technology to the field of deployable wings in a manner that is unique and original in the art. This novel approach incorporates many of the advantages inherent in conventional inflatable wings while directly addressing the weaknesses of prior designs. Construction materials for this wing are not limited to the use of B-stage cured planar stock, but can be accomplished using a variety of rigidizable materials being found in various stock forms. However, other methods, such as resin transfer molding could be used to fabricate the wings.

Many advantages are realized in an inflatable, rigidizable wing, the most notable of which is an increase in stiffness compared to a conventional inflatable wing. This improvement is potentially on the order of several orders of magnitude. This allows the potential to construct thinner, higher aspect ratio wings than has been possible using conventional inflatable wing approaches. A thinner, higher aspect ratio wing possesses favorable aerodynamic characteristics, the most significant of which is lower drag, hence improved fuel economy and lift to drag ratio. A further advantage is that by eliminating the dependence on inflation gas to maintain shape, an inflatable, rigidizable wing is less prone to failure due to puncture. Since the wing only relies on the presence of inflation gas to initially deploy and maintain shape while rigidization occurs, the potential is created to make use of a lower pressure inflation system. The possibility is also realized of being able to eject the inflation system from the vehicle after the rigidization process has occurred, resulting in reduced aircraft weight. These and other advantages of the invention will be apparent in view of the following disclosure.

### BRIEF DESCRIPTION OF THE DRAWINGS

FIG. 1 illustrates the underlying structure of a wing constructed using inflatable tubes.

FIG. 2 shows a covering attached over the wing in FIG. 1.

FIG. 3 is a cross section of a rigidizable composite tube.

FIG. 4 illustrates an underlying structure of a wing constructed using spars to connect an upper and lower structural surface (spar and restraint approach).

FIG. 5 shows a covering stretched over the wing in FIG. 3.

FIG. 6 is a cross section showing a construction of the wing of FIG. 4.

FIG. 7 is a cross section of a composite layup sheet (prepreg).

FIG. 8 illustrates the concept of a wing based on a covering stretched over separated plates that are in the shape of an airfoil.

### DETAILED DESCRIPTION

Three embodiments of inflatable/expandable, rigidizable wings are described below. For purposes of the description, the rigidizing technique described is based on an light cure (photo-initiation) rigidization mechanism. It is understood that this is but one of several cure mechanisms upon which the rigidization process can be based. For example, any type of light capable photo-initiating rigidization process, i.e., ultraviolet, visible and infrared light, can be used, or the gas used to expand may be, or may contain a curing agent to rigidify the wing. Such curing agent-containing gas may also be introduced to the wing after it has been fully expanded. Further, the means of deployment described is based upon the use of an inflation gas. However, it is understood that other means of deployment could be used, such as mechanical linkages, shape memory materials, and so forth.

As used throughout the specification and claims, the term “self supporting” means without the need for internal pressure. That is to say, a “self supporting structure” is capable of maintaining its general size and shape sua sponte. Moreover, as used herein, the term “rigidizable” means flexible until acted upon. Thus, until a rigidizable structure is, for example, cured or otherwise acted upon, it is foldable and bendable. However, after being acted upon and “rigidified”, the structure is self supporting and maintains its shape.

Inflatable/expandable, rigidizable technology is applied to deployable space structures such as antennas, solar arrays, and solar sails. These applications accomplish rigidization using ultraviolet light from the sun or from internal sources such as light emitting diodes (LEDs) or embedded fibers. The timing of the rigidization event is controlled by the resin chemistry and can be on the order of tens of seconds. The wavelength at which the material rigidizes can be shifted to accommodate manufacturing and field use needs as required. The rigidization process is not reversible in the case of UV curable materials and is thus a one-time event. A variety of reinforcement fabrics can be used, but glass or quartz based fabrics are normally preferred to facilitate transmission of UV light. Distributed reinforcements of higher performance fibers such as carbon can be used if required to further optimize structural efficiency.

Tube Based Construction

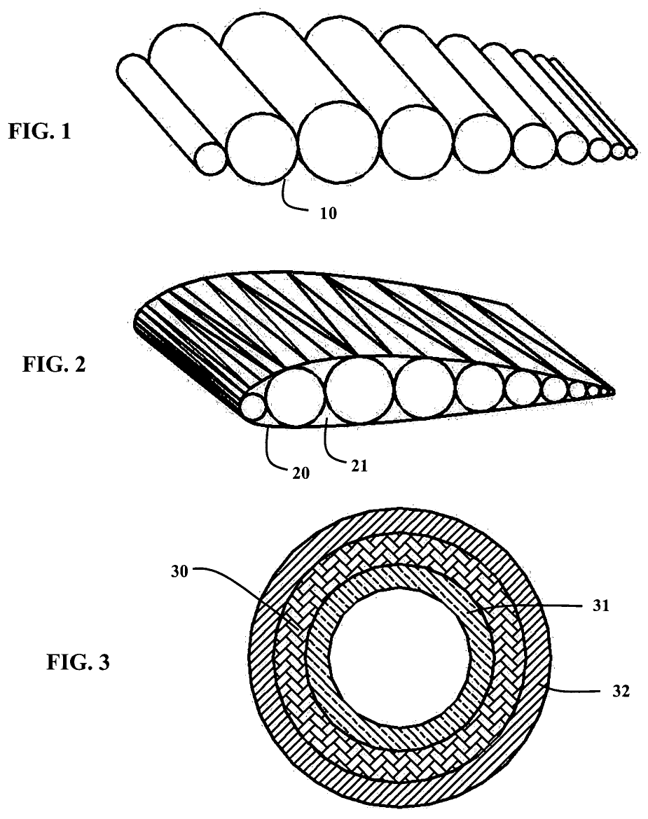

One embodiment of an underlying structure of a wing based on inflatable/expandable, rigidizable tubes is shown in FIG. 1. The figure depicts a series of such tubes 10 joined tangentially by an adhesive or similar technique. The tubes 10 are of varying diameters, arranged in a way to achieve the desired aerodynamic shape of the wing. As shown in FIG. 2, a flexible material such as a fabric or film 20 is typically used to form a smooth aerodynamic covering over the arrangement of tubes. A flexible support structure such as an open cell foam 21 may additionally be provided under the covering 20 to maintain the covering 20 in the proper spatial position to create the desired aerodynamic shape. The tubes 10 may be fitted with gas tight end caps 22 (not shown) at each end, with a suitable provision to allow the entry of inflation gas. The resulting tubular structure may be attached to flat end plates 23 (not shown) that are constructed in the desired aerodynamic shape. Alternatively, the gas source may be internal of the inflatable material, which only needs to be activated. For example, an internal compressed gas cylinder can be opened to release the gas to expand the inflatable material, or a gas-generating chemical reaction can be used to direct the resulting gasses in to the structure. The inflation gas can also be in the form of an encapsulated liquid or solid that vaporizes or sublimates to inflate the wing after the encapsulation device is opened or otherwise activated by a contained or external method. Similarly, the inflation gas may be contained in an internal or external tank, such as a conventional carbon dioxide canister, such that when the canister is opened, the carbon dioxide exits the canister and inflates the structure. Such inflation methods can be activated via an external switch or simply be removing the expandable material from a container. Further, the material may be provided with other devices which cause the material to expand, such as shape-memory materials, or springs, which, when the structure is removed from a confining space, tend to expand the structure without the need for the application of an externally applied force such as the gasses discussed above.

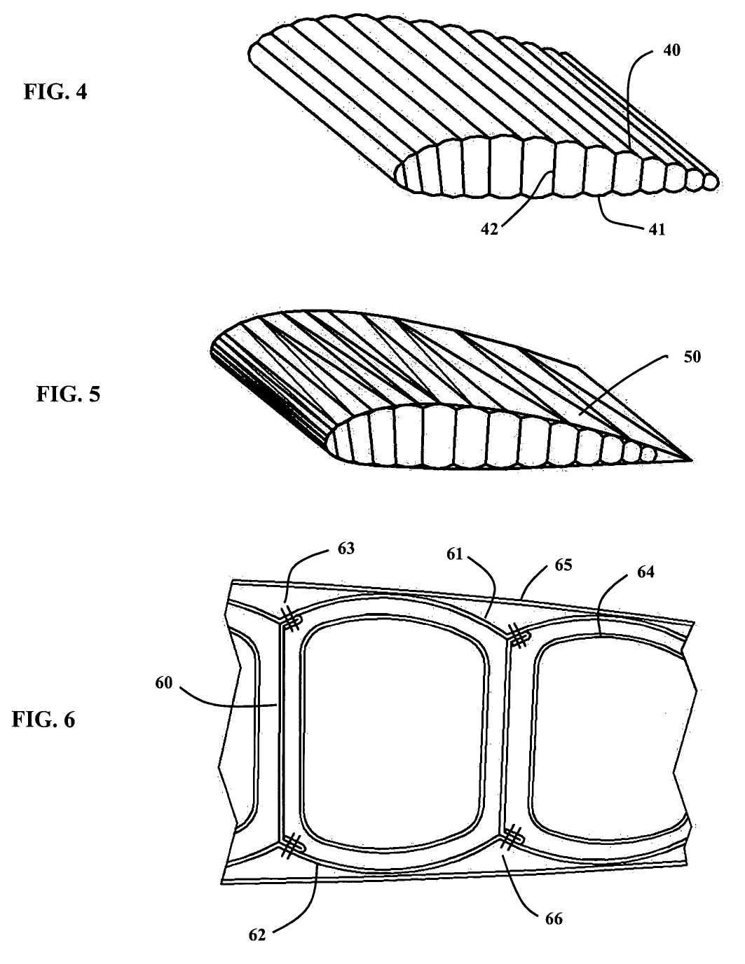

The inflatable/expandable, rigidizable tubes may consist of a multi-layer material as shown in the tube cross section of FIG. 3. A rigidizable layer, reinforcement or prepreg layer, 30 is shown as the middle layer, and typically comprises reinforcing fibers, typically in the form of woven, non-woven, knitted or felt sheets, or oriented bundles of fibers called tows. This reinforcement layer 30 is typically impregnated with an uncured polymeric resin using any technique that known in the art. The resulting intermingled fabric/resin material is known commonly in the art as “prepreg”. The prepreg layer 30 is, in a preferred embodiment, surrounded by an additional layer on both the interior and exterior of the tube. The interior layer 31 may be a gas-retaining layer such as a polymer film, which is also transparent to UV light. The outer layer 32 is typically also transparent to UV light, and may serve to prevent the packed tube from sticking to itself during deployment, a condition known in the art as “blocking”. Both the inner and outer layers 31, 32 generally protect the inner prepreg layer 30, retaining any excess resin that may exude from the prepreg. A wing constructed from tubes having the reinforcement layer 30, inner layer 31 and outer layer 32, is preferred because the resin is not fully uncured, but preferably is in a “B”-stage of cure (i.e., is partially cured), enabling the structure to be packed into a small volume by folding or rolling or similar technique. Such a packed wing may be stowed in a packing container. While FIG. 3 depicts the reinforcing layer 30 between one inner layer 31 and one outer layer 32, it is considered within the scope of this invention to vary the number and locations of the various layers. For example, a tube may include multiple reinforcing layers 30, sandwiched between any number of inner layers 31 and/or outer layers 32. Additionally, one or both of the inner layer 31 and outer layer 32 may be eliminated completely without detracting from the invention. In another preferred embodiment, the resin is in a completely uncured state. In this embodiment, the resin is preferably a highly viscous resin that will not run, such as a Rigidized-On-Command (ROC) Resin. A preferred ROC resin is ATI ROC E371X1 Resin, available from Adherent Technologies, Inc. of Albuquerque, New Mex.

Deployment of the wing is typically accomplished by filling the tubes with an inflation gas. This gas can be supplied from a compressed gas tank or from a chemical reaction. Additionally, the inflation gas may be provided with a fan or a port disposed at a location on the structure which allows an air flow to enter the structure. For example, if the compressed or non-deployed structure were accelerated through the air with one or more ports oriented correctly, the passage of the structure through the air can be used to generate an air flow into the ports to inflate the structure. As the tubes are inflated, the wing can be deployed out of its packing container, or alternatively removed from the packing container prior to deployment. It is additionally considered within the scope of the invention to incorporate the container into the expandable structure, such that no external container is required. In such a construction, for example, the walls of a break-away container can be formed from the walls of the expandable material. In any event, after the wing fully achieves its shape, the tubes typically caused to become rigid by curing the resin within the prepreg. The activation energy to initiate this cure can be supplied by, for example, UV light. Such a light source can be ambient light from the environment, or from an internal UV source such as a series of UV light emitting diodes (LED's) mounted, for example, internal to the wing, or UV LED's that are in the form of fibers or are physically embedded in the structural fabric. In one embodiment, the LED's deliver blue/green light, i.e., either a single light of between 400 and 550 nm or multiple lights, one between 400 and 450 nm, and a second between 450 and 550 nm. After the rigidization process is complete, the inflation gas can be retained, or vented as desired.

Additionally, the elements of the wing may include internal structures for assisting the activation of the curing. For example, light transmitting elements, such as optical fibers can be attached to or imbedded in the cover or internal elements of the wing. Preferably, these light transmitting elements are fed by LEDs or laser light from an outside location and bleed light over their lengths or optical fibers of various lengths may be arranged in cables in order to distribute the photo-initiation light. For example, a UV, IR or visible, light generating element can be positioned at the root of the wing, and located as to distribute the UV light through the optical fibers to the elements to be rigidized. The surface of the wing may be covered with an opaque material to eliminate external exposure and contain internal exposure of light from the illumination source. Additionally, an aluminum coated material may be used to reflect light back into the fabric for enhanced curing.

Spar and Restraint Construction

A spar and restraint construction approach is illustrated in FIG. 4. A top surface 40 and a bottom surface 41, collectively known as a restraint, are connected by a plurality of spars 42, the length of which and spacing between which are chosen to achieve an underlying structure that approximates an aerodynamic shape. A covering 50 can be stretched (see FIG. 5) over the resulting structure to achieve a smooth shape, in a manner similar to that described previously. A typical cross section of this construction is shown in FIG. 6. Spars 60 are shown as being connected to an upper surface 61 and a lower surface 62 by means of stitching 63 as shown, or with adhesive or similar methods. A gas retaining bladder 64, typically a polymer film, is preferably fitted between the spars to prevent inflation gas from leaking through the holes created by the stitching. By nature, an inflatable seeks to take the shape of a surface of revolution, hence, upon inflation, the construction approach being described assumes a “bumpy” shape, with the bumps occurring midway between the spars. In order to achieve a smooth aerodynamic surface, a covering 65 is typically stretched between the bumps. This covering may be supported with a foam material 66 that fills the valley between the bumps as described earlier, or it may simply be stretched taut, or tensioned between the peaks of the bumps during construction. The covering may be a fabric, a coated fabric, a film, or a rigidizable material.

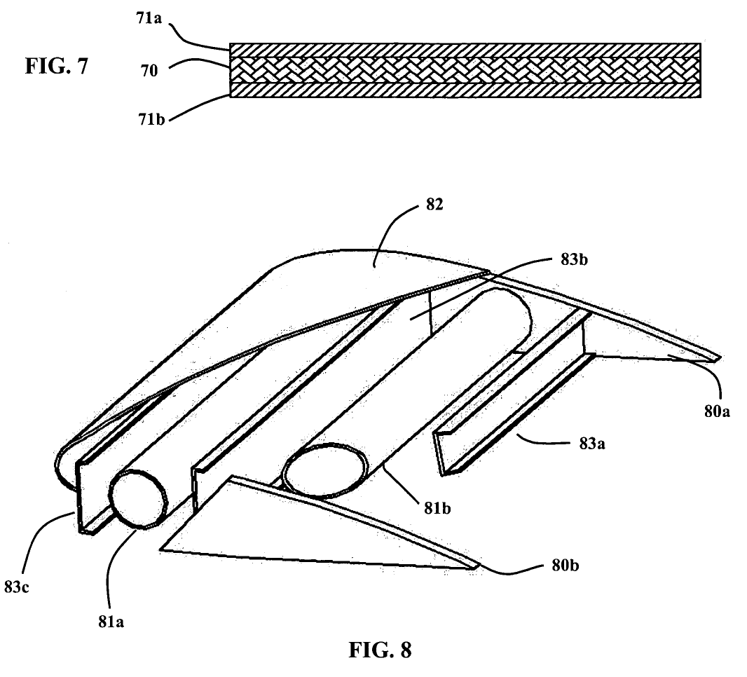

The spars, upper surface, lower surface and optionally the covering, may each be constructed using a rigidizable material of similar makeup to that used for the tube-based construction described earlier. FIG. 7 shows an illustration of such a material. Planar or roll stock of rigidizable material is comprised of three layers. An inner prepreg layer 70 as described earlier, can be sandwiched between two layers of UV transparent anti-blocking material 71, also as described earlier.

Deployment and rigidization are typically accomplished as described earlier.

Spar and Tube Construction

This is a third embodiment of the present invention, and includes elements of both embodiments described above. Unlike the other two methods, this approach achieves its aerodynamic shape by causing a covering to conform to two endplates 80a, 80b that possess the desired shape, as shown in FIG. 8. The plates 80a, 80b are separated by one or more coated fabric inflatable tubes 81 or other mechanical means, with the covering 82 spanning between the separated plates. Structural strength is provided by a plurality of rigidizable spars 83 constructed and attached to the covering as described earlier. Unlike the spar and restraint approach described, there is no inflation pressure contained by the covering, so it does not try to expand to a surface of revolution, and thus creates no undesired bumps. This method provides less support for the covering, and uses fewer spars. As such, in order to provide sufficient strength, these elements are typically constructed using thicker materials or additional plies of rigidizable material versus the single ply construction described earlier. Additionally, reinforcement ribs (not shown) may be attached at periodic intervals under the covering, arranged in an orientation similar to the orientation of a traditionally constructed aircraft wing rib to provide additional support to the covering.

Deployment and rigidization maybe accomplished as described earlier.

It is additionally considered within the scope of the invention to include structures which can change the shape of the wing after it has been rigidized. For example, cables may be attached to the trailing edges of the wing and to another part of the aircraft, such that when the cable is tensioned, the wing can warp to create control surfaces. Such cables may be included in a yoke-system to allow the application simultaneous tension to multiple sections of the wing. As is generally known in the aerospace arts, such wing warping may be used to control various forces acting on the wing and the aircraft in general.

The expandable/inflatable rigidizable elements of this invention may also be incorporated into other structures. For example, a life raft may include an expandable rigidizable mast to which a sail may be affixed. Thus, when the life raft is deployed, the user has the option of expanding the mast from its stowed and compact position to its deployed, upright position. Thus, in an emergency situation, a life boat, or any boat for that matter, can be quickly converted from a raft to a sailboat. Additionally, expandable oars or paddles can be stowed either in or near the life boat, and when needed, the oars can be expanded and rigidified to allow propulsion of the boat.

The aforementioned description of several embodiments of the present invention has been presented for purposes of illustration and description. It is not intended to be exhaustive or to limit the invention to the precise form disclosed, and obviously many modifications and variations are possible in light of the above description. While this description refers to a wing, included embodiments are understood to include other aerodynamic devices such as winglets, stabilizers, tail surfaces, control surfaces, fairings and the like, such as an aircraft wing, an aircraft winglet, an aircraft control surface, an aircraft canard, an aircraft horizontal stabilizer, an aircraft vertical stabilizer or any other aircraft empennage. While the description describes a cantilevered wing, it is considered obvious that wire or strut braced wings, or wings connected to payloads using suspension lines can also be made using these descriptions. It is further considered obvious that the invention can be applied to such structures operating within other fluid media, such as water, or planetary atmospheres. The embodiments described were chosen to explain the principles of the invention and the practical application thereof, thereby enabling others skilled in the art to use the invention as described or with various modifications as are suited to the particular use contemplated.

1. A rigidizable wing comprising:
an upper surface;
a lower surface;
and a support structure, disposed between and supporting the upper surface and lower surfaces;
wherein at least one of the upper surface, lower surface and the support structure are rigidizable, such that the wing is self supporting.

2. The rigidizable wing of claim 1, wherein the support structure comprises at least one of a tube and a spar.

3. The rigidizable wing of claim 2, wherein the support structure comprises a series of tubes, joined tangentially.

4. The rigidizable wing of claim 3, wherein the series of tubes comprise tubes of different widths.

5. The rigidizable wing of claim 4, wherein the upper surface is tensioned across the series of tubes.

6. The rigidizable wing of claim 3, wherein at least one of the series of tubes is inflatable.

7. The rigidizable wing of claim 6, wherein at least one of the series of tubes is rigidizable.

8. The rigidizable wing of claim 1, further comprising a foam between the support structure and at least one of the upper surface and the lower surface.

9. The rigidizable wing of claim 2, wherein the support structure comprises a plurality of spars.

10. The rigidizable wing of claim 9, further comprising at least one gas retaining bladder, positioned between the spars.

11. The rigidizable wing of claim 2, wherein the support structure comprises spars and tubes.

12. The rigidizable wing of claim 11, wherein the support structure comprises a plurality of alternating tubes and spars.

13. The rigidizable wing of claim 11, further comprising at least one endplate separated by the tubes and spars.

14. The rigidizable wing of claim 1, wherein the at least one of the upper surface, lower surface and the support structure comprise a rigidizable layer, and optionally at least one other layer.

15. The rigidizable wing of claim 1, wherein the at least one of the upper surface, lower surface and the support structure comprises reinforcing fibers.

16. The rigidizable wing of claim 14, further comprising a first layer on a first side of the rigidizable layer and a second layer on a second side of the rigidizable layer.

17. The rigidizable wing of claim 16, wherein at least one of the first layer and the second layer is transparent to a photo-initiating light.

18. The rigidizable wing of claim 17, wherein the photo-initiating light is ultraviolet light.

19. The rigidizable wing of claim 16, wherein at least one of the first layer and the second layer comprises an antiblocking agent.

20. The rigidizable wing of claim 1, wherein the at least one of the upper surface, lower surface and the support structure comprise light-bleeding optical fibers.

21. The rigidizable wing of claim 20, further comprising a photo-initiating light connected to the optical fibers.

22. The rigidizable wing of claim 20, further comprising an opaque cover disposed over the surface of the wing.

23. The rigidizable wing of claim 1, wherein at least one of the upper surface, the lower surface and the support structure comprise at least one element selected from the group consisting of conductive fibers, electrically activated fibers, an antenna, sensors and an electronic device.

24. The rigidizable wing of claim 1, wherein at least one of the upper surface, the lower surface and the support structure comprise at least one element selected from the group consisting of a battery, a solar cell, and means for adjusting the shape of the wing.

25. The rigidizable wing of claim 1, wherein the wing is an aerodynamic structure selected from the group consisting of an aircraft wing, an aircraft winglet, an aircraft control surface, an aircraft canard, an aircraft horizontal stabilizer, and an aircraft vertical stabilizer.

26. The rigidizable wing of claim 1, further comprising means for warping the wing.

27. The rigidizable wing of claim 1, further comprising at least one cable attached to a trailing edge of the wing, positioned to allow the application of tension to the trailing edge.

27. A kit comprising:
the rigidizable wing of claim 1, wherein the wing is in a collapsed condition; and
means for expanding the wing.

28. A process for forming a wing comprising:
providing a non-rigid structure, the non-rigid structure comprising an upper surface, a lower surface, and a support structure;
expanding the structure; and
rigidifying the non-rigid structure.

29. The process of claim 28, wherein the expanding comprises deploying the non-rigid structure from a container.

30. The process of claim 28, wherein the expanding comprises inflating the non-rigid structure.

31. The process of claim 29, wherein the support structure includes at least one tube and the inflating comprises applying air pressure to the at least one tube of the support structure.

32. The process of claim 28, wherein the rigidifying comprises applying a photo-initiating light.

33. The process of claim 32, wherein the photo-initiating light is ultraviolet.

34. The process of claim 32, wherein the rigidifying comprises passing the photo-initiating through optical fibers attached to or imbedded in the structure.

35. A rigidizable structure comprising:
an element comprising an photo-initiatable, uncured polymeric material and
optical fibers attached to the polymeric material,
wherein a photo-initiating light passed through the optical fibers causes the structure to become rigid and self supporting.
